(19) United States
(12) Patent Application Publication
(10) Pub. No.: US 2015/0372521 A1
(43) Pub. Date: Dec. 24, 2015

(54) Portable Power Bank

(71) Applicant: LausDeo Corporation, Yangmei City (TW)

(72) Inventors: MING-CHIEH LIN, Taichung City (TW); CHUN-LIANG YANG, Taichung City (TW); WEN-HSIANG CHANG, Taichung City (TW); JUNG KUO, Taichung City (TW); MENG-KWEI HSU, Taichung City (TW)

(21) Appl. No.: 14/455,942

(22) Filed: Aug. 10, 2014

(30) Foreign Application Priority Data
Jun. 19, 2014 (TW) 103121118

(51) Int. Cl. H02J 7/00

(52) U.S. Cl. CPC H02J 7/0065; H02J 7/0029; H02J 7/0042; H02J 7/0047; H02J 2007/0067

(57) ABSTRACT

The present invention provides a power bank comprising a battery protection board, controller board, and a host connector. The host connector is compatible with an accessory connector on a fast charger board, and the host connector is connected to the accessory connector for boosting the charging rate of the power bank. The fast charger board connected to the power bank may, for powering laptops and electric bicycles, elevate the output voltage of the power bank to 12V or above. The power bank may further connect with other external components, such as an LED module and a wireless transceiver module, in order to extend the functionality of the power bank.

### TECHNICAL FIELD

At least one embodiment in accordance with the present invention relates to a power bank. More particularly, at least one embodiment relates to a power bank comprising several ports for connecting with external components in order to extend the functionality of the power bank.

### DESCRIPTION OF THE RELATED ART

A power bank is configured for supplying electric energy to electronic devices. In recent years, the demand for batteries has been increasing for supporting a full day's use of mobile devices. However, the current fashion tenting to use embedded batteries instead of removable batteries subsequently stimulates the development of power banks as an alternative solution.

Conventional power banks provide only one single function which is to charge the electronic devices. Several All-in-One power banks were proposed recently in response to the growing demand from people nowadays. An All-in-One power bank usually integrates a card reader, a wireless switch, or other devices into one conventional power bank, and therefore provides multiple functions in a single power bank. Nevertheless, the integration of several devices may increase the weight, volume, and cost of a power bank. Besides, an All-in-One power bank sometimes may pack in and offer some functions which are not that useful to the users.

The All-in-One power banks, originally designed to supply electrical energy to the electronic devices, now consume a significant portion of the electrical energy in maintaining the activities of those integrated devices. Accordingly, there is a need for a power bank with high flexibility to provide options to the users.

### SUMMARY

At least one embodiment of the present invention provides a power bank characterized by the ability to connect with external components for extending the functionality of the power bank. The power bank has improvements in the weight, volume, cost, and energy lost which are long denounced as defects of conventional power banks or All-in-One power banks

In some embodiments of the present invention, the power bank comprises a battery protection board, a controller board, and a host connector. The battery protection board and host connector are connected with the controller board respectively. The battery protection board comprises at least two rechargeable batteries and a battery protection module connected to the at least two rechargeable batteries. The at least two rechargeable batteries are lithium-ion batteries connected in series and are each selected from the group consisting of a LiFePO₄ battery, a LiNiO₂ battery, a Li(NiMnCo)O₂ battery and a LiCoO₂ battery. In the aforementioned embodiments, each battery provides an output voltage in the range of 3.2 to 4.3 volt.

In some embodiments, the battery protection module comprises a battery protection chip, a charge MOSFET, and a discharge MOSFET. The at least two rechargeable batteries receive electrical energy from the controller board via the battery protection chip, and then output the electrical energy to an external device via the battery protection chip and the controller board.

In some embodiments, the charge/discharge processes of the power bank are regulated by the controller board. The controller board comprises a charging port for receiving an input current, a charge detector connected to the charging port, a DC-to-DC input converter connected to the charge detector, and a constant-voltage charger connected to the DC-to-DC input converter. The controller board also comprises at least one multifunctional port for powering a device, at least one discharge detector connected to the at least one multifunctional port, and at least one DC-to-DC output converter connected between the at least one discharge detector and the battery protection module. Moreover, a host detector connected to the host connector is also comprised in the controller board. As a node, a power path switch controller on the controller board is connected to the constant-voltage charger, the host detector, and the battery protection module respectively. Another node on the controller board is a microcontroller unit which is connected to the constant-voltage charger, the at least one DC-to-DC output converter, and a light-emitting indicator respectively. The light-emitting indicator is configured as a power indicator.

In some embodiments, the charge process comprises the steps of: (i) connecting the charging port to an external power supply for receiving a direct current (DC) power; (ii) transporting the DC power to the DC-to-DC input converter through the charge detector; (iii) converting, by the DC-to-DC input converter, the voltage of the DC power to a range appropriate for charging the at least two rechargeable batteries; (iv) transporting the DC power to the constant-voltage charger; (v) converting, by the constant-voltage charger, the DC power to a constant-voltage power (CV) input current; (vi) transporting the CV input current to the battery protection board through power path switch controller; and (vii) charging the at least two rechargeable batteries with the CV input current via the battery protection chip and the charge MOSFET.

In some aspects of the aforementioned embodiments, the charge detector is configured to detect the influx current from the charging port, and the constant-voltage charger may communicate with the microcontroller unit bidirectionally. Moreover, the microcontroller is configured to receive a first information, the voltage received by the constant-voltage charger, from the constant-voltage charger and control the constant-voltage charger to provide a CV input current based on the first information. The power path switch controller is configured to direct the power flow. In these cases, the power path switch controller directs a route for the power flow from the charging port to the at least two rechargeable batteries by maintaining the electrical connection with the constant-voltage charger.

In some embodiments, the discharge process comprises the steps of: (i) connecting an external device or an external component to the at least two multifunctional port; (ii) generating, by the at least two rechargeable batteries, an output current to the at least one DC-to-DC output converter through the battery protection chip and the discharge MOSFET; (iii) converting, by the DC-to-DC output converter, the voltage of the output current to a range appropriate for supplying the external device or the external component; and (iv) supplying the output current to the external device or the external component via the at least one multifunctional port.

In some aspects of the aforementioned embodiments, the at least one discharge detector is configured to detect the connection between the power bank and the external device or the external component. The microcontroller unit is configured to detect a second information, the battery level of the at least two rechargeable batteries, and instruct the light-emitting indicator to display the second information. Moreover, the microcontroller unit may communicate with the at least one DC-to-DC output converter bidirectionally.

In some other aspects of the aforementioned embodiments, the discharge process further comprises the determining steps for determining the voltage appropriate for supplying the external device or the external component. The determining steps comprise the steps of: (i) identifying, by the at least one discharge detector, a third information which is about the voltage appropriate for supplying the external device or the external components; (ii) delivering the third information to the microcontroller unit via the at least one DC-to-DC output converter; and (iii) instructing, by the microcontroller unit, the DC-to-DC converter to convert the voltage of the output current to a range appropriate for supplying the external device or the external component based on the third information.

In some embodiments, the host connector may be further connected with a fast charger board for elevating the charge rate of the power bank. The fast charger board includes an alternating current (AC) port for receiving an AC power, a rectifier connected to the AC port, a high-power DC-to-DC converter connected to the rectifier, a constant-voltage fast charger connected to the high-power DC-to-DC converter, and an accessory connector connected with the constant-voltage fast charger. In these embodiments, the constant-voltage fast charger is a high-power charger for providing a CV input current. Moreover, the accessory connector is capable of connecting with the host connector.

In some aspects of the aforementioned embodiments, the host detector is configured to detect the connection between the host connector and the accessory connector. The power path switch controller is configured to direct the power flow. In these cases, the power path switch controller reroutes the power flow by breaking the electrical connection with the constant-voltage charger and forming a new connection with the host connector via the host detector.

In some embodiments, the fast charge process, when executed by a power bank connected with a fast charger board, comprises the steps of: (i) connecting the AC port to an external power supply for receiving an AC power; (ii) transporting the AC power to the rectifier for converting the AC power to a DC power; (iii) transporting the DC power to the constant-voltage fast charger through the high-power DC-to-DC converter; (iv) converting, by the constant-voltage fast charger, the DC power to a CV input current; and (v) providing the CV input current to the power bank through the accessory connector and the host connector.

In some aspects of the aforementioned embodiments, the microcontroller unit is configured to receive a fourth information, the values of voltage and current appropriate for charging the power bank, in order to charge the power bank safely and efficiently. Moreover, the microcontroller unit communicates with the constant-voltage fast charger bidirectionally through the host connector.

In some embodiments, the fast charger board further comprises a boost module including a boost transformer connected to the accessory connector and a fast charging port connected to the boost transformer. The boost module is configured to supply high-voltage output current to external devices (e.g., laptops) which need a higher voltage to finish the charge.

In some aspects of the aforementioned embodiments, the discharge process, when executed by power bank connected with a fast charger board including a boost module, comprises the steps of: (i) connecting the accessory connector to the at least one multifunctional port; (ii) generating, by the power bank, an output current; (iii) transporting the output current to the boost transformer; (iv) converting, by the boost transformer, the output current into a high voltage output current; and (v) providing the high voltage output current to the external device via the fast charging port.

In some embodiments, the power bank may extend the functionality by connecting with an external component via the at least one multifunctional port. The external component may, for example, be a light module or a wireless transceiver module. The light module may be one of the LED lamps with different colors. The wireless transceiver module may be a wireless 3G switch or a wireless 4G switch. Moreover, the external component may connect together or be unified as a single external component. For example, a wireless transceiver module may connect onto a light module, or be comprised in a fast charger board. In the cases that the wireless transceiver module is comprised in a fast charger board, the wireless transceiver module connects to the power bank through the connection between the accessory connector and the at least one multifunctional port and therefore be supplied with a DC output current from the power bank.

At least one embodiment of the present invention provides power banks with high flexibility. The power banks may optionally connect with other external components in order to extend the functionality of the power bank, and therefore improve several defects found in conventional power banks

### BRIEF DESCRIPTION OF THE DRAWINGS

FIG. 1 is a schematic diagram illustrating a power bank in accordance with at least one embodiment of the present invention.

FIG. 2 is a schematic diagram illustrating a power bank with a fast charger board in accordance with at least one embodiment of the present invention.

FIG. 2A is a schematic diagram illustrating a power bank with a fast charger board and a boost module in accordance with at least one embodiment of the present invention.

FIG. 2B is a schematic diagram illustrating a power bank with a fast charger board and a wireless transceiver module in accordance with at least one embodiment of the present invention.

FIG. 3 is a schematic diagram illustrating a power bank with a fast charger board and a light module in accordance with at least one embodiment of the present invention.

FIG. 4 is a schematic diagram illustrating a power bank with a fast charger board, a light module, and a wireless transceiver module in accordance with at least one embodiment of the present invention.

### DESCRIPTION OF THE PREFERRED EMBODIMENTS

In a general aspect, at least one embodiment in accordance with the present invention relates to a power bank. More particularly, at least one embodiment relates to a power bank comprising several ports for connecting with external components in order to extend the functionality of the power bank. The embodiments and drawings provided here show different aspects of the present invention. However, the present invention is limited to neither the embodiments nor the drawings thereof.

Some embodiments of the present invention comprise a standard charging mode and a fast charging mode.

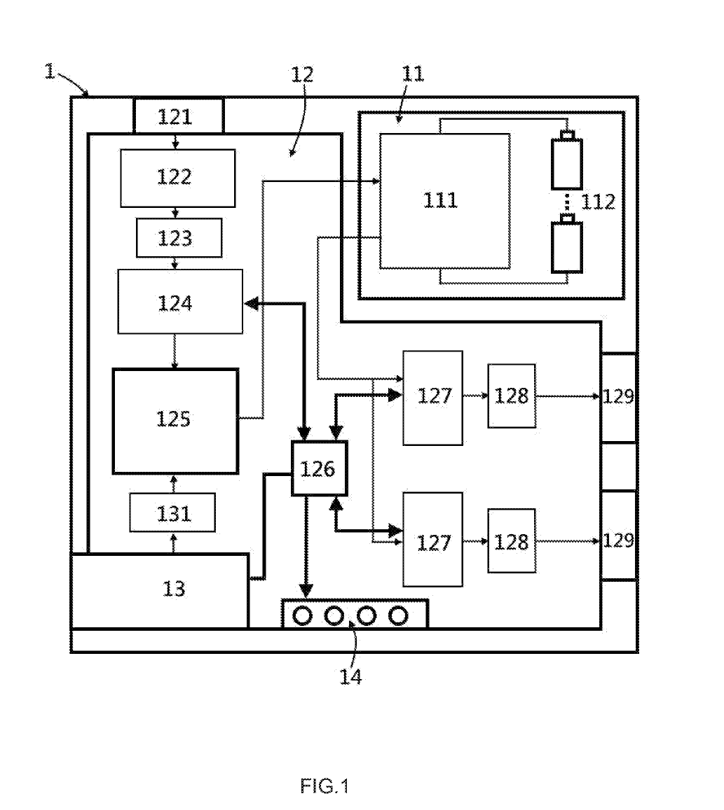

FIG. 1 is a schematic diagram illustrating a power bank in accordance with at least one embodiment of the present invention. FIG. 1 is also used as an exemplary power bank for performing the standard charging mode. The power bank 1 in FIG. 1 comprises a battery protection board 11, a controller board 12, and a host connector 13. The battery protection board 11 and the host connector 13 are connected with the controller board 12 respectively. However, the host connector 13 may be comprised in the controller board 12 in some other embodiments.

In the embodiments of FIG. 1, the battery protection board 11 comprises at least two rechargeable batteries 112 and a battery protection module 111 connected to the at least two rechargeable batteries 112.

The controller board 12 comprises a charging port 121 for receiving an input current, a charge detector 122 connected to the charging port 121, a DC-to-DC input converter 123 connected to the charge detector 122, and a constant-voltage charger 124 connected to the DC-to-DC input converter 123. The controller board 12 also comprises at least one multifunctional port 129 for supplying an output current, at least one discharge detector 128 connected to the at least one multifunctional port 129, and at least one DC-to-DC output converter 127 connected between the at least one discharge detector 128 and the battery protection module 111. Moreover, a host detector 131 connected to the host connector 13 is also comprised in the controller board 12. As a node, a power path switch controller 125 is configured on the controller board 12 to connect the constant-voltage fast charger 124, the host detector 131, and the battery protection module 111 respectively. Another node comprised on the controller board 12 is a microcontroller unit 126. The microcontroller unit 126 is connected respectively to the constant-voltage charger 124, the at least one DC-to-DC output converter 127, and a light-emitting module 14.

In some embodiments of FIG. 1, the charging port 121 is a micro-USB port. The DC-to-DC input converter 123 is a 5W DC-to-DC converter and the constant-voltage charger 124 is a 5W DC-to-DC charger. Moreover, the connection between the constant-voltage charger 124 and the microcontroller unit 126 is configured to provide a bidirectional communication to determine the ranges of voltage and current appropriate for charging the at least two rechargeable batteries 112. The charge detector 122 is configured to detect the influx current from the charging port 121. The power path switch controller 125 is configured to direct the path of power flow. In the standard charging mode, the power path switch controller 125 directs a route for the power flow from the charging port 121 to the at least two rechargeable batteries 112 by maintaining the electrical connection with the constant-voltage charger 124.

To perform the standard charging mode with the power bank 1 in FIG. 1, the charging port 121 is first connected to an external power supply for receiving a direct current (DC) power. Through the charge detector 122, the DC-to-DC input converter 123 subsequently changes the voltage of the DC power received by the charging port 121. For supplying a stable power to charge the at least two rechargeable batteries 112 safely, the constant-voltage charger 124 further converts the DC power to a constant-voltage (CV) input current. The CV input current is then transported to the battery protection board 11 via the power path switch controller 125. Finally, the CV input current is used to charge the at least two rechargeable batteries 112 via the battery protection chip 111 and the charge MOSFET.

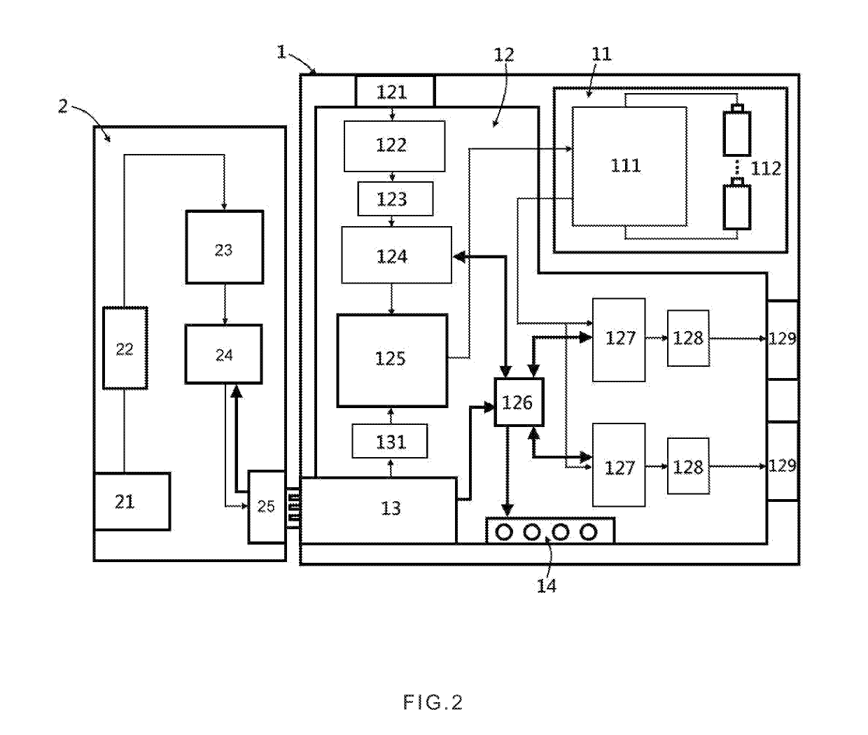

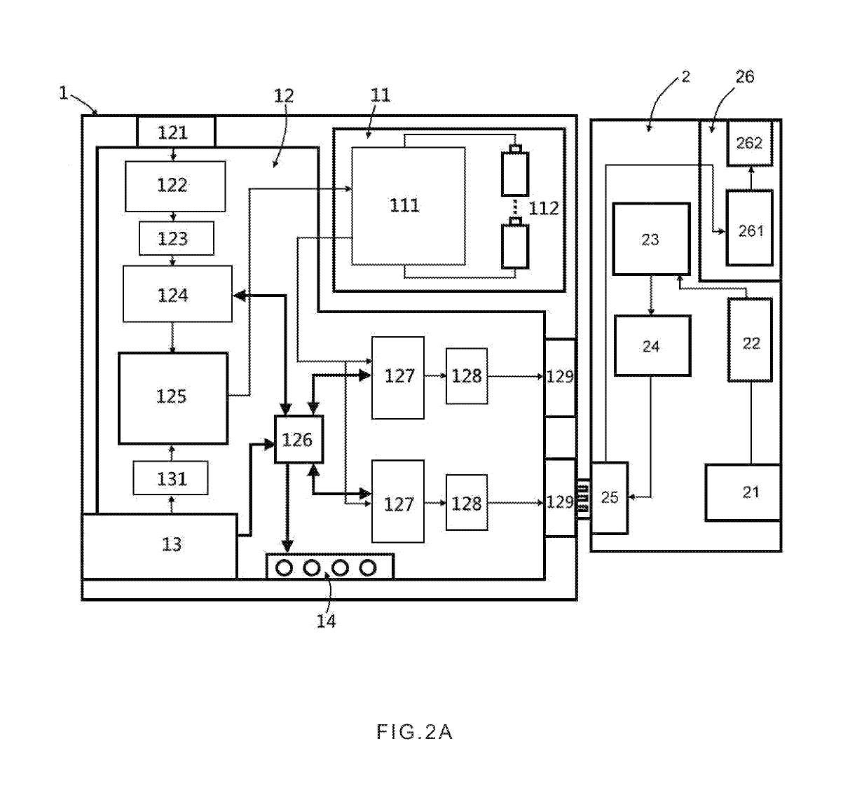

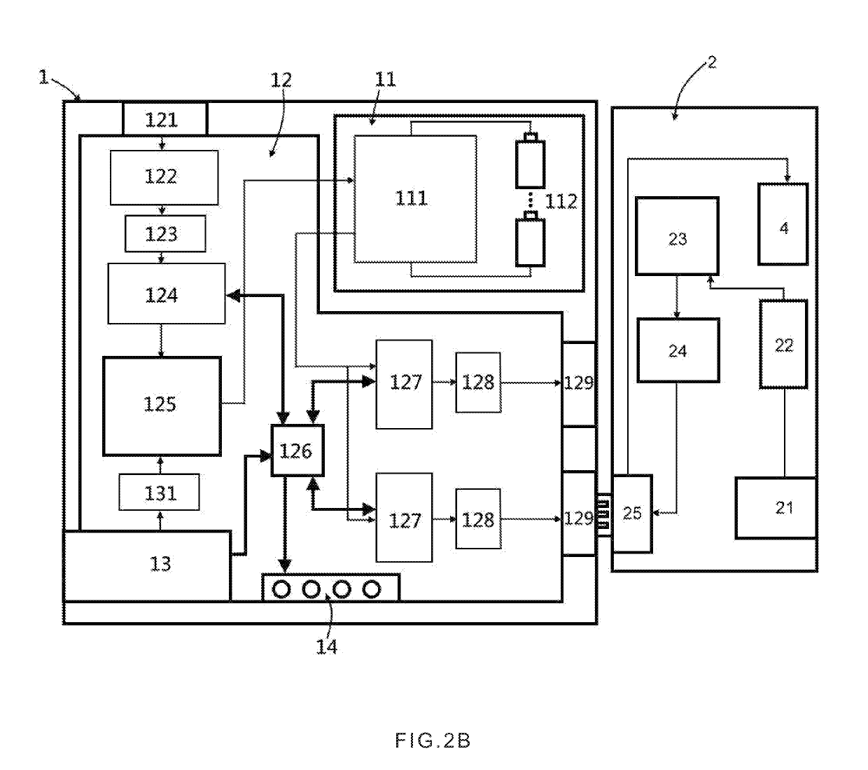

FIG. 2 is a schematic diagram illustrating a power bank with a fast charger board in accordance with at least one embodiment of the present invention. The power bank in FIG. 2 is also used as an exemplary power bank for performing the fast charging mode. Based on the embodiments of FIG. 1, the host connector 13 in FIG. 2 is further connected with a fast charger board 2 for elevating the charge rate of the power bank 1. The fast charger board 2 comprises an alternating current (AC) port 21 for receiving an AC power, a rectifier 22 connected to the AC port 21, a high-power DC-to-DC converter 23 connected to the rectifier 22, a constant-voltage fast charger 24 connected to the high-power DC-to-DC converter 23, and an accessory connector 25 connected with the constant-voltage fast charger 24. The accessory connector 25 is capable of connecting with the host connector 13.

In some embodiments of FIG. 2, the high-power DC-to-DC converter 23 is a 60W DC-to-DC converter. The constant-voltage fast charger 24 is a 60W charger, and the connection between the constant-voltage fast charger 24 and, through the host connector 13, the microcontroller unit 126 is for providing a bidirectional communication to determine the values of voltage and current appropriate for charging the at least two rechargeable batteries 112. Moreover, the host detector 131 is configured to detect the connection between the accessory connector 25 and the host connector 13. In the fast charging mode, the power path switch controller 125 is configured to direct the path of power flow by breaking the electrical connection between the battery protection board 11 and the constant-voltage charger 124 and forming a new connection between the battery protection board 11 and the fast charger board 2.

To perform the fast charging mode with the power bank 1 in FIG. 2, the AC port 21 is first connected to an external power supply for receiving an AC power. For providing a DC power to the at least two rechargeable batteries 112, the AC power from the AC port 21 may be transported to the rectifier 22 for conversion. Through the high-power DC-to-DC converter 23, the constant-voltage fast charger 24 then converts the DC power to a CV input current and provides the CV input current to the at least two rechargeable batteries 112 via the accessory connector 25 and the host connector 13.

FIGS. 2A-2B are schematic diagrams representing the alternate embodiments of a fast charger board 2. FIG. 2A illustrating a power bank 1 with a fast charger board 2 and a boost module 26 in accordance with at least one embodiment of the present invention. The boost module 26 comprises a boost transformer 261 connected to the accessory connector 25 and a fast charging port 262 connected to the boost transformer 261. The boost module 26, connected with the power bank 1 via the USB connection between the accessory connector 25 and the multifunctional port 129, is configured to power external devices (e.g., laptops and electric bicycles) which need a higher voltage to finish the charge. The boost transformer 261 elevates the voltage of an output current generated from the at least two rechargeable batteries 112 to 12V or above to supply the external devices via the fast charging port 262.

FIG. 2B is a schematic diagram illustrating a power bank 1 with a fast charger board 2 and a wireless transceiver module 4 in accordance with at least one embodiment of the present invention. The wireless transceiver module 4, comprised in the fast charger board 2, is connected with the multifunctional port 129 via the accessory connector 25. The wireless transceiver module 4 may be a wireless switch and is powered by an output current generated from the power bank 1.

However, in some embodiments of the present invention, the power bank 1 may directly connect with external components via the multifunctional ports 129 instead of via the fast charger board 2 as an intermediate.

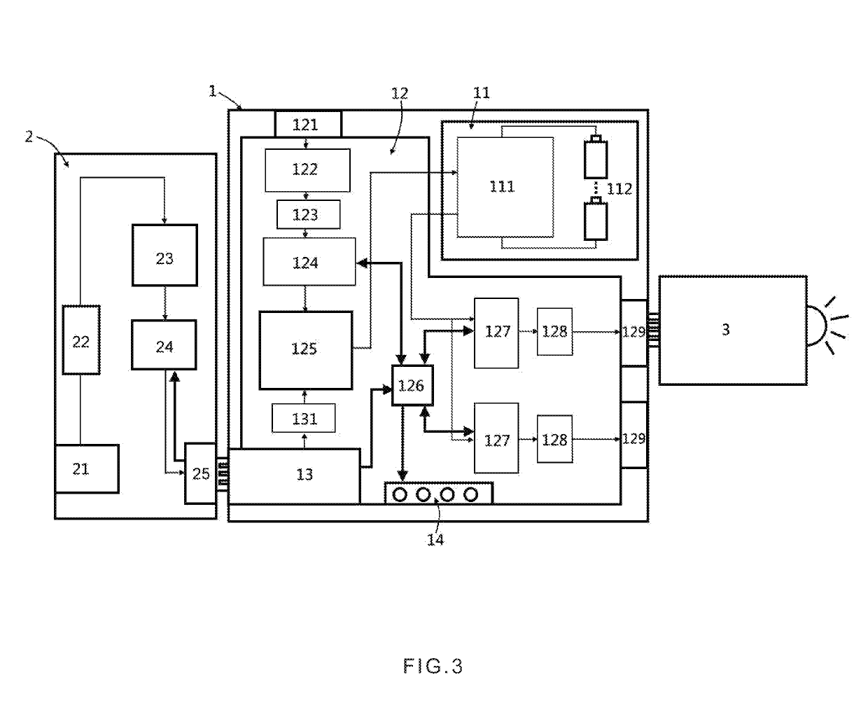

FIG. 3 is a schematic diagram illustrating a power bank 1 with a fast charger board 2 and a light module 3 in accordance with at least one embodiment of the present invention. The power bank 1 comprises two multifunctional ports 129 for connecting with external devices and external components and supplying power to the external devices and the external components. The external components are connected to the multifunctional port 129 for extending the functionality of the power bank 1. For example, the power bank 1 in FIG. 3 is connected with an external component, a light module 3, via one of the two multifunctional ports 129 and the external component is powered by the at least two rechargeable batteries 112.

In some embodiments of FIG. 3, the two DC-to-DC output converters 127 are 10W converters. The two DC-to-DC output converters 127 communicate with the microcontroller unit 126 bidirectionally to regulate the voltage and the output current generated from the at least two rechargeable batteries 112. Furthermore, the microcontroller unit 126 is connected with a light-emitting indicator 14 as a power indicator. The light-emitting indicator 14 may display the battery level of the power bank 1 by brightness or by color.

To power an external device or an external component with the power bank 1 in FIG. 3, an external device or an external component is first connected to one of the two multifunctional ports 129 of the power bank 1. The connection is subsequently detected by a discharge detector 128 and the at least two rechargeable batteries 112 are then allowed to generate an output current. The output current from the at least two rechargeable batteries 112 moves to a DC-to-DC output converter 127 through the battery protection chip 111 and the discharge MOSFET. Via the connected multifunctional port 129, the output current is eventually supplied to the external device or the external component.

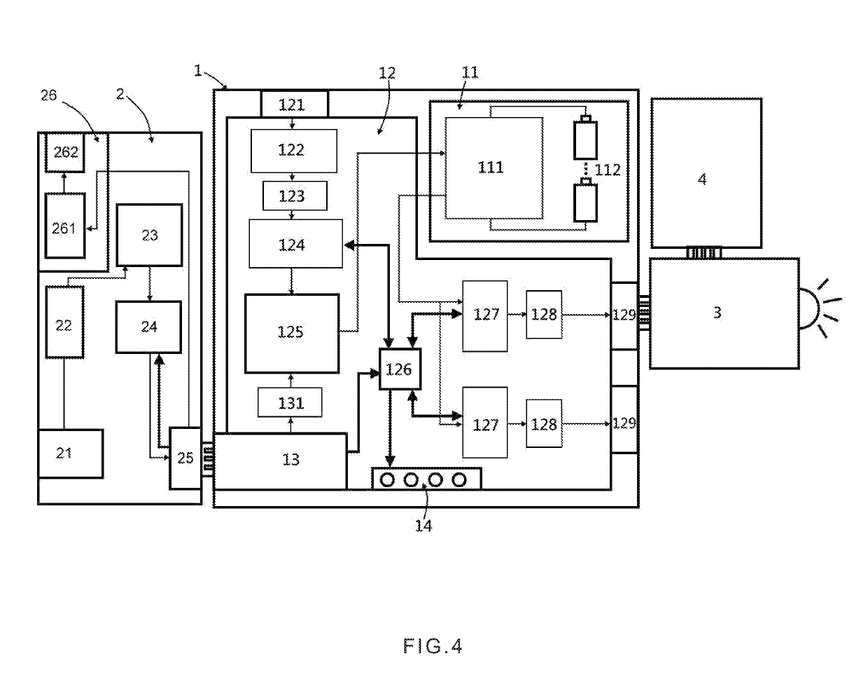

FIG. 4 is a schematic diagram illustrating a power bank 1 with a fast charger board 2, a light module 3, and a wireless transceiver module 4 in accordance with at least one embodiment of the present invention. In some embodiments of FIG. 4, a wireless transceiver module 4 may, based on the demand of a user, connect onto the light module 3 of FIG. 3 to further extend the functionality of the power bank 1. In some alternate embodiments of FIG. 4, a wireless transceiver module 4 may first connected to the power bank 1, and a light module 3 is then connected to the wireless transceiver module 4. The connection between the power bank 1 and the external component and the connection between external components may be achieved by standard USB plugs and USB ports. The power bank 1 provides various combinations to the users, and therefore is sufficient to satisfy different demands.

What is claimed is:

1. A power bank, comprising:
a battery protection board including:
at least two rechargeable batteries; and
a battery protection module connected to the at least two rechargeable batteries;
a controller board, electrically connected with the battery protection board, including:
a charging port for receiving an input current;
a charge detector connected to the charging port;
a direct current to direct current (DC-to-DC) input converter connected to the charge detector;
a constant-voltage charger connected to the DC-to-DC input converter;
at least one multifunctional port for supplying an output current;
at least one discharge detector connected to the at least one multifunctional port;
at least one DC-to-DC output converter connected between the at least one discharge detector and the battery protection module;
a host connector;
a host detector connected to the host connector;
a power path switch controller respectively connected to the constant-voltage charger, the host detector, and the battery protection module; and
a microcontroller unit respectively connected to the constant-voltage charger, the at least one DC-to-DC output converter; and
a light-emitting indicator, wherein the light-emitting indicator is configured as a power indicator.

2. The power bank as claimed in claim 1, wherein the at least two rechargeable batteries are connected in series.

3. The power bank as claimed in claim 1, wherein the at least two rechargeable batteries are each selected from the group consisting of a LiFePO₄ battery, a LiNiO₂ battery, a Li(NiMnCo)O₂ battery and a LiCoO₂ battery.

4. The power bank as claimed in claim 1, wherein the battery protection module comprises a battery protection chip, a charge Metal Oxide Semiconductor Field Effect Transistor (MOSFET), and a discharge MOSFET.

5. The power bank as claimed in claim 1, wherein the DC-to-DC input converter is a 5W DC-to-DC converter.

6. The power bank as claimed in claim 1, wherein the constant-voltage charger is a 5W charger supplying a constant-voltage power.

7. The power bank as claimed in claim 1, wherein the at least one DC-to-DC output converter is a 10W DC-to-DC converter.

8. The power bank as claimed in claim 1, wherein the charging port is a micro-USB (Universal Serial Bus) port.

9. The power bank as claimed in claim 1, wherein the at least one multifunctional port is a USB port.

10. The power bank as claimed in claim 1, wherein the light-emitting unit is an LED (light-emitting diode) power indicator.

11. The power bank as claimed in claim 1, wherein the power bank further comprises a fast charger board including:
an AC (alternating current) port for receiving an alternating current power;
a rectifier connected to the AC port;
a high-power DC-to-DC converter connected to the rectifier;
a constant-voltage fast charger connected to the high-power DC-to-DC converter; and
an accessory connector connected with the constant-voltage fast charger, wherein the accessory connector is capable of connecting with the host connector.

12. The power bank as claimed in claim 11, wherein the high-power DC-to-DC converter is a 60W DC-to-DC converter.

13. The power bank as claimed in claim 11, wherein the constant-voltage fast charger is a 60W charger supplying a constant-voltage power.

14. The power bank as claimed in claim 11, wherein the constant-voltage fast charger is connected with the microcontroller unit via the accessory connector.

15. The power bank as claimed in claim 1, wherein the power bank further comprises a light module capable of connecting with the at least one multifunctional port.

16. The power bank as claimed in claim 15, wherein the power bank further comprises a wireless transceiver module capable of connecting with the light module.

17. The power bank as claimed in claim 1, wherein the power bank further comprises wireless transceiver module capable of connecting with the at least one multifunctional port.

18. The power bank as claimed in claim 17, wherein the power bank further comprises a light module capable of connecting with the wireless transceiver module.

19. The power bank as claimed in claim 11, wherein the fast charger board further comprises a boost module including:
a boost transformer connected to the accessory connector; and
a fast charging port connected to the boost transformer.

20. The power bank as claimed in claim 11, wherein the fast charger board further comprises a wireless transceiver module connected to the accessory connector.
